(19) United States
(12) Patent Application Publication
(10) Pub. No.: US 2011/0285616 A1
(43) Pub. Date: Nov. 24, 2011

(54) ELECTRONIC BOOK

(75) Inventors: BIN GONG, Shenzhen City (CN); MING-CHANG LEE, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/823,317

(22) Filed: Jun. 25, 2010

(30) Foreign Application Priority Data
May 21, 2010 (CN) 201010179568.6

(51) Int. Cl. G09G 3/34

(52) U.S. Cl. 345/107

(57) ABSTRACT

An electronic book includes an upper shell and an inner frame mounted under the upper shell. The inner frame includes a main body, an electrophoretic display mounted in the main body, a front light guide plate mounted in the main body and located above the electrophoretic display, and a lighting body mounted to the main body and located at a side of the front light guide plate.

### BACKGROUND

1. Technical Field

The present disclosure relates to an electronic book.

2. Description of Related Art

Due to small size, light weight, and ease of storage, electronic books are widely used. A conventional electronic book includes an electrophoretic display (EPD). However, the electrophoretic display is only visible when externally lit.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of an electronic book.

FIG. 2 is an assembled view of the electronic book of FIG. 1.

FIG. 3 is a sectional view of the electronic book, taken along the line III-III of FIG. 2.

### DETAILED DESCRIPTION

The disclosure, including the accompanying, is illustrated by way of examples and not by way of limitation. It should be noted that references to “an” or “one” embodiment in this disclosure are not necessarily to the same embodiment, and such references mean at least one.

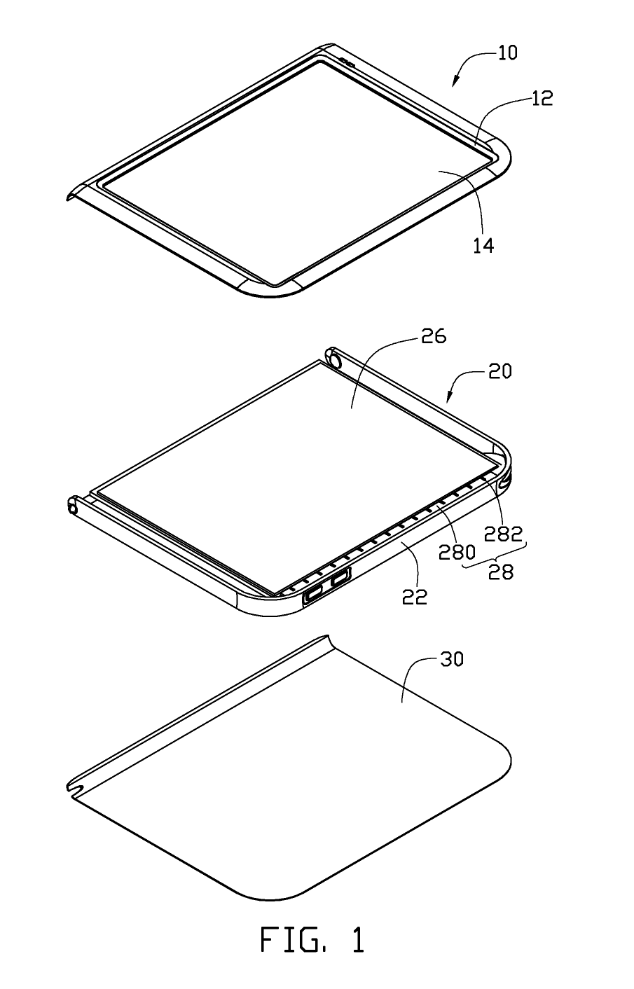

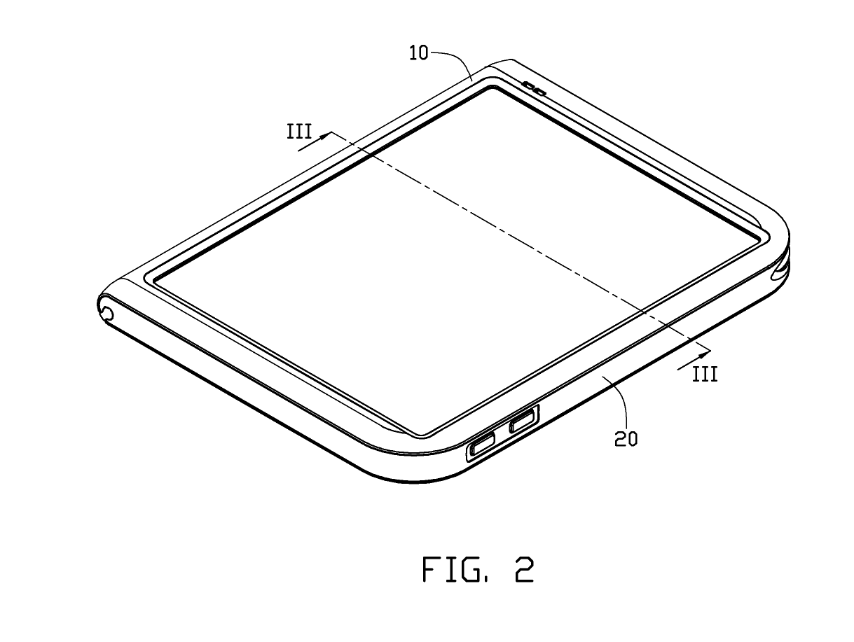

Referring to FIGS. 1 and 2, an exemplary embodiment of an electronic book includes an upper shell 10, an inner frame 20, and a lower shell 30.

The upper shell 10 is rectangular and defines a rectangular opening 12. A transparent element, such as protecting glass 14, is accommodated in the opening 12.

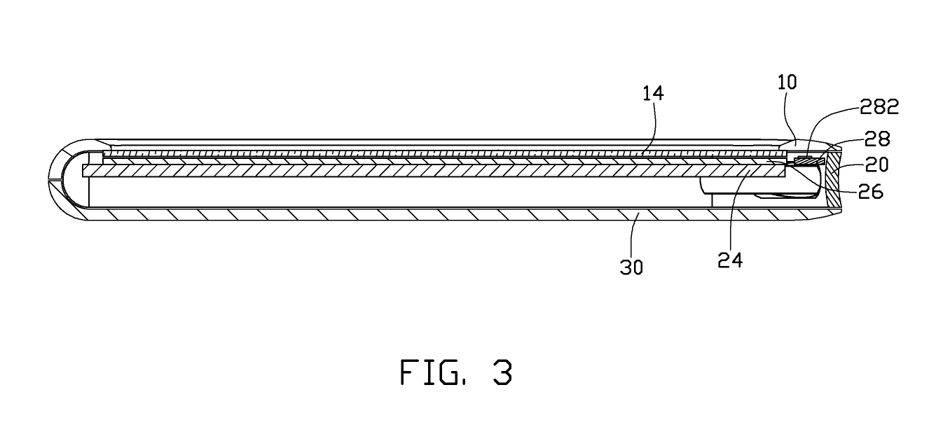

Referring to FIG. 3, the inner frame 20 includes a main body 22, an electrophoretic display 24 mounted in the main body 22, a front light guide plate 26 mounted in the main body 22 and located above the electrophoretic display 24, and a lighting body 28 mounded to the main body 22 and located at a side of the front light guide plate 26. The lighting body 28 is higher than the front light guide plate 26.

The front light guide plate 26 includes a plurality of astigmatism points formed by printing or molding. The lighting body 28 includes a printed circuit board 280 and a plurality of lighting elements 282 installed on the printed circuit board 280. The lighting elements 282 are electrically connected together by the printed circuit board 280. In this embodiment, each lighting element 282 is a light emitting diode. The lighting body 28 is turned on and off by a switch or a program.

The inner frame 20 is mounted between the lower shell 30 and the upper shell 10. The glass 14 is disposed above and aligned with the front light guide plate 26.

When the electronic book is used in darkness, the lighting body 28 is turned on. The lighting body 28 lights the front light guide plate 26, the light is scattered by the front light guide plate 26 onto the electrophoretic display 24 by the astigmatism points of the front light guide plate 26.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic book comprising:
an upper shell; and
an inner frame mounted under the upper shell and comprising a main body, an electrophoretic display mounted in the main body, a front light guide plate mounted in the main body and located above the electrophoretic display, and a lighting body mounded to the main body and located at a side of the front light guide plate.

2. The electronic book of claim 1, wherein the lighting body comprises a printed circuit board and a plurality of lighting elements installed on the printed circuit board, the plurality of lighting elements are electrically connected together via the printed circuit board.

3. The electronic book of claim 2, wherein each lighting element is a light emitting diode.

4. The electronic book of claim 1, wherein the front light guide plate comprises a plurality of astigmatism points, when the lighting body is turned on, the lighting body lights on the front light guide plate, the light lighting the front light guide plate is scattered onto the electrophoretic display by the astigmatism points.

5. The electronic book of claim 1, wherein the astigmatism points are formed by printing or molding.

6. The electronic book of claim 1, wherein the upper shell is rectangular and defines a rectangular opening, a transparent element is accommodated in the opening and aligned with the front light guide plate.

7. The electronic book of claim 6, wherein the transparent element is glass.

8. The electronic book of claim 1, further comprising a lower shell, wherein the inner fame is mounted between the upper shell and the lower shell.
